(19) United States
(12) Patent Application Publication
(10) Pub. No.: US 2024/0314829 A1
(43) Pub. Date: Sep. 19, 2024

(54) CONTROL APPARATUS, CONTROLLED APPARATUS, AND COMMUNICATION SYSTEM

(71) Applicant: Futaba Corporation, Mobara-shi (JP)

(72) Inventor: Masahiro TANAKA, Mobara-shi (JP)

(21) Appl. No.: 18/589,878

(22) Filed: Feb. 28, 2024

(30) Foreign Application Priority Data
Mar. 14, 2023 (JP) 2023-040071

(51) Int. Cl. H04W 72/542; H04B 1/715; H04B 17/23; H04B 17/345; H04W 72/0453

(52) U.S. Cl. CPC H04W 72/542; H04B 1/715; H04B 17/23; H04B 17/345; H04W 72/0453; H04B 2001/7154

(57) ABSTRACT

A control apparatus is provided. The control apparatus comprises: a control part configured to determine a channel selection order in frequency hopping; a transmitter configured to transmit transmission data at a frequency corresponding to a selected channel selected based on the selection order; and a receiver configured to receive, in response to the transmission, reception data from a communication target device at a frequency corresponding to the selected channel, wherein the reception data includes radio field strength information on a measurement channel of a measurement target that is a channel used for the frequency hopping.

### CROSS-REFERENCE TO RELATED APPLICATIONS

This application claims priority to Japanese Patent Application No. 2023-040071 filed on Mar. 14, 2023, the entire contents of which are incorporated herein by reference.

### TECHNICAL FIELD

The present disclosure relates to a control apparatus, a controlled apparatus, and a communication system; and, more particularly, to a field of a control apparatus, a controlled apparatus, and a communication system that performs communication while appropriately changing channels using frequency hopping.

### BACKGROUND

In a device that performs remote control by wireless communication, such as a model airplane, a drone, or the like, a communication environment in a flight area is important, and appropriate control cannot be performed when the communication environment is poor.

Therefore, a study is being conducted to measure the presence of interference waves in the control area in advance.

For example, as disclosed in Japanese Laid-open Patent Publication No. 2018-155710, a measurer obtains radio field strength data for the control area by flying an unmanned aircraft within predetermined space (control area).

### SUMMARY

However, for the method for flying an unmanned aircraft in the flight area as in Japanese Laid-open Patent Publication No. 2018-155710, a long period of time is required for preliminary measurement, which is not appropriate.

Further, in some cases, it is not possible to secure measurement time in advance.

In view of the above, the object of the present disclosure is to reduce the investigation time for measuring the communication environment.

A control apparatus according to the present disclosure comprises; a control part configured to determine a channel selection order in frequency hopping; a transmitter configured to transmit transmission data at a frequency corresponding to a selected channel selected based on the selection order; and a receiver configured to receive, in response to the transmission, reception data from a communication target device at a frequency corresponding to the selected channel, herein the reception data includes radio field strength information on a measurement channel of a measurement target that is a channel used for the frequency hopping.

For example, the communication target device is a manipulation target device that can be remotely controlled, e.g., a multicopter such as a drone or a radio control model. Further, the control apparatus is a controller operated by a user to control a manipulation target device to be remotely controlled.

In this case, the control information (posture control information) for controlling a manipulation target device is transmitted from a transmitter, so that the control result from the manipulation target device or various types of telemetry information on the manipulation target device are received from a receiver.

By using the transmission and reception of such information, it is possible to perform remote control of the manipulation target device using the controller.

The above-described transmission and reception is a normal transmission and reception operation for remotely controlling the manipulation target device. In accordance with this configuration, the radio field strength information can be received from the manipulation target device during the normal transmission and reception.

A controlled apparatus according to the present disclosure comprises: a receiver configured to perform reception of a reception data at a frequency according to a selected channel selected from a plurality of channels used for frequency hopping; a control part configured to measure radio field strength information on a measurement channel of a measurement target that is a channel used for the frequency hopping; and a transmitter configured to performs, in response to the reception, transmission of a transmission data at a frequency corresponding to the selected channel used in the reception to the control apparatus, wherein the transmission data includes the radio field strength information measured by the control part between the reception of the reception data and the transmission of the transmission data.

A communication system according to the present disclosure includes a control apparatus and a controlled apparatus, wherein the control apparatus includes: a control part configured to determine a channel selection order in frequency hopping; and a transmitter configured to transmit transmission data at a frequency corresponding to a selected channel selected based on the selection order, and the controlled apparatus includes: a receiver configured to receive the transmission data at a frequency according to the selected channel; a control part configured to measures radio field strength information on a measurement channel of a measurement target that is a channel used for the frequency hopping; and a transmitter configured to perform, in response to the reception, transmission of return data including the radio field strength information at a frequency corresponding to the selected channel to the control apparatus.

The same operational effects can also be obtained by the above-described controlled apparatus or communication system.

### BRIEF DESCRIPTION OF THE DRAWINGS

FIG. 1 is a functional block diagram of a controller and a controlled object constituting a communication system according to an embodiment of the present disclosure.

FIG. 2 is a perspective view showing an outer shape of the controller.

FIG. 3 shows an example of a data structure of a message packet as transmission data.

FIG. 4 shows an example of a data structure of a message packet as return data.

FIG. 5 explains data transmission and reception by frequency hopping.

FIG. 6 shows an example of a display part of the controller in which a spectrum is displayed based on radio field strength information.

FIG. 7 is a flowchart showing an example of processing executed by the controller in conjunction with FIG. 8.

FIG. 8 is a flowchart showing an example of processing performed by the controller subsequent to FIG. 7.

FIG. 9 is a flowchart showing an example of processing executed by a controlled apparatus in conjunction with FIG. 10.

FIG. 10 is a flowchart showing an example of processing executed by the controlled apparatus subsequent to FIG. 9.

FIG. 11 is a flowchart of an example of processing executed by the controller to display the spectrum on the display part.

FIG. 12 is a flowchart of an example of warning processing executed by the controller.

FIG. 13 is a flowchart of an example of warning condition setting executed by the controller.

FIG. 14 explains data transmission and reception by frequency hopping in a second embodiment.

FIG. 15 explains data transmission and reception by frequency hopping in a third embodiment.

FIG. 16 is a flowchart showing an example of processing executed by the controller in the third embodiment subsequent to FIG. 7.

### DETAILED DESCRIPTION

Hereinafter, embodiments will be described in the following order.
<1. Configuration of communication system>
<2. Structure of message packet>
<2-1. Transmission data>
<2-2. Return data>
<3. RSSI value measurement timing>
<4. Spectrum display>
<5. Processing flow>
6. Second Embodiment
7. Third Embodiment
<8. Modifications>

### 1. Configuration of Communication System

Hereinafter, a communication system S of a first embodiment will be described with reference to the drawings.

The communication system S includes a controller 1 and a controlled device 2 that is remotely controlled by the controller 1.

The controller 1 is a control apparatus that transmits control information for control to the controlled device 2. Further, the controlled device 2 is a manipulation target device that receives the control information from the controller 1 and changes its posture or the like.

The controller 1 includes an antenna 3 for wireless communication, a communication part 4 for transmitting and receiving data via the antenna 3, a control part 5 for performing various processes, a manipulation part 6 for allowing user's manipulation inputs, and a display part 7 for displaying various information to an operator.

The antenna 3 can transmit and receive radio waves in a frequency band from about 2.4 GHz to about 2.5 GHZ, for example.

The antenna 3 may be configured to transmit and receive radio waves near each of frequency bands such as 27 MHz, 40 MHZ, 72 MHZ, 73 MHZ, 429 MHZ, 920 MHz, 1.2 GHZ, 5 GHZ, 6 GHZ, and the like without being limited thereto. Further, the antenna 3 may be configured to transmit and receive radio waves in these multiple frequency bands.

Such frequency bands are considered to be used by the communication system S in Japan. Therefore, it is preferable that such frequency bands are appropriately different depending on countries or regions where the communication system S is used. In other words, it is preferable that the communication system S includes the antenna 3 that corresponds to available frequency bands while observing regulations.

The communication system S of the present embodiment changes a channel CH to be used whenever the controller 1 and the controlled device 2 transmit a message packet. In other words, after the transmission and reception of the packet is performed, the controller 1 performs frequency hopping for changing the channel CH used for wireless communication.

The communication part 4 is configured, for example, as an integrated circuit (IC) in which a transmitter 4S and a receiver 4R are integrated. In the communication part 4, a modulator, a power amplifier, a high frequency amplifier, and a demodulator are integrated.

Further, the IC constituting the transmitter 4S and the IC constituting the receiver 4R may be provided separately.

The communication part 4 of the present embodiment performs transmission and reception for each message packet.

The transmitter 4S executes processing of transmitting the message packet transmitted from the control part 5 to the controlled device 2.

The receiver 4R receives a message packet transmitted from the controlled device 2, and executes processing of transmitting the message packet to the control part 5.

The communication part 4 may be configured to include a buffer memory for transmitting and receiving a message packet or the like.

The control part 5 generates a message packet storing information to be transmitted to the controlled device 2, and supplies the generated message packet to the transmitter 4S.

Further, the control part 5 analyzes a header portion of the message packet received from the controlled device 2 via the receiver 4R, and performs various processes depending on circumstances. For example, the control part 5 receives various measurement information such as a control voltage value for the controlled device 2 or a remaining battery power as telemetry information, and performs control corresponding to the telemetry information. Further, the telemetry information may include current location information such as latitude information and longitude information of the controlled device 2, or altitude information when the controlled device 2 is a flying object.

Specifically, as will be described later, the control part 5 determines the presence or absence of interference waves or the intensity thereof based on radio wave strength information (received signal strength indicator (RSSI)) included in the message packet received from the controlled device 2.

Further, the control part 5 performs processing of adaptively changing the frequency hopping pattern depending on the intensity of the interference wave, or changes the channel CH to be selected.

The control part 5 can execute warning processing based on the radio field strength information.

The control part 5 performs various processes based on the manipulation signal detected by the manipulation part 6 in response to an operator's manipulation of the manipulation part 6. Various processes include, e.g., transmitting control information included in a message packet based on the operator's manipulation of the controlled device 2, and the like. In addition, the control part 5 performs various processes such as menu display processing and setting change processing in response to user's manipulation of the menu.

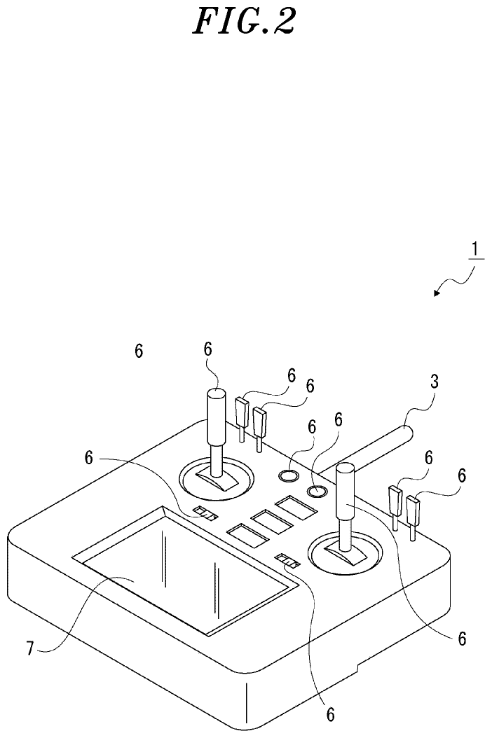

The manipulation part 6 includes, for example, a manipulation element for changing the posture or the moving direction of the controlled device 2, a manipulation element for moving the controlled device 2 in a predetermined direction, a manipulation element provided to correspond to the driving part of the controlled device 2, or the like (see FIG. 2). Further, a cross key, a decision button, a cancel button, a slide switch, or the like for manipulating the menu displayed on the display part 7 may be included in the manipulation part 6.

The manipulation part 6 includes a manipulation element capable of setting a warning condition for determining whether or not to execute the above-described warning process.

The display part 7 may include a display on which various images or data are displayed, and the display may have a touch panel function. When the display has a touch panel function, the display functions as the manipulation part 6 as well as the display part 7.

The controlled device 2 includes an antenna 8 for wireless communication, a communication part 9 for transmitting and receiving data via the antenna 8, a control part 10 for performing various processes, and various driving parts 11.

Further, the controlled device 2 may be provided with other devices depending on purpose, such as a camera device and the like.

The antenna 8 can receive radio waves transmitted from the antenna 3 of the controller 1. In other words, in the present embodiment, the antenna 3 can transmit and receive radio waves in the frequency band from about 2.4 GHz to about 2.5 GHz.

The communication part 9 is configured as an IC in which a transmitter 9S and a receiver 9R are integrated. In the communication part 9, a modulator, a power amplifier, a high frequency amplifier, and a demodulator are integrated.

Further, the IC constituting the transmitter 9S and the IC constituting the receiver 9R may be provided separately.

The control part 10 analyzes the header portion of the message packet received from the controller 1 via the receiver 9R, and performs various processes corresponding to circumstances. For example, the control part 10 drives the driving part 11 based on the control information included in the message packet. Hence, the posture of the controlled device 2 is changed, and the moving direction, the speed, and the like are changed.

The control part 10 generates a message packet in which various measurement information such as a control voltage value for the controlled device 2 or a remaining battery power is stored as telemetry information, and provides the message packet to the transmitter 9S. As described above, the telemetry information may include position information of the controlled device 2 or the like.

The control part 10 acquires radio field strength information on a predetermined channel CH in a predetermined band (e.g., 2.4 GHz band) received by the receiver 9R.

The control part 10 stores the acquired radio field strength information together with the telemetry information in a predetermined area of the message packet, and transmits it to the controller 1 via the transmitter 9S.

Various driving parts 11 are provided depending on types of the controlled device 2. For example, when the controlled device 2 is a multicopter such as a drone or the like, the driving part 11 includes a motor for driving a propeller or the like. When the controlled device 2 is an aircraft with fixed wings, the driving part 11 includes a motor for driving an aileron, a rudder, or an elevator.

Further, when the controlled device 2 is not a flying device but a model vehicle imitating a car or the like, the driving part 11 includes a motor for driving wheels, a motor for steering, or the like.

### 2. Structure of Message Packet

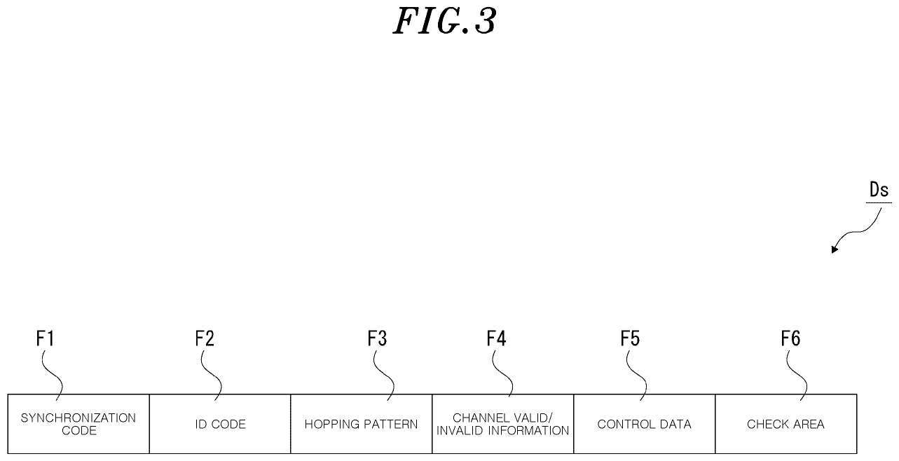

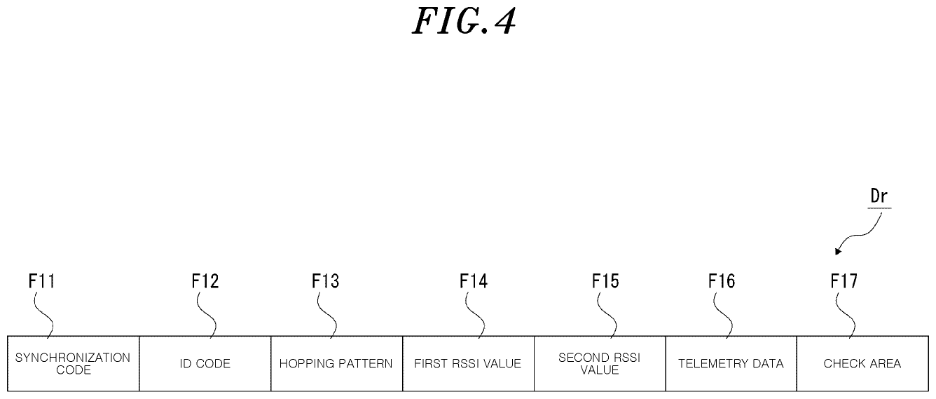

An example of a structure of a message packet used in the communication system S will be described with reference to FIGS. 3 and 4.

### 2-1. Transmission Data

FIG. 3 shows an example of a structure of a message packet in a transmission data Ds transmitted from the controller 1. Further, the transmission data Ds may be the reception data in view of the controlled device 2.

The transmission data Ds includes a synchronization code area F1, an identification (ID) code area F2, a hopping pattern area F3, a channel valid/invalid information area F4, a control data area F5, and a check area F6. Although FIG. 3 shows a part of the data structure of the message packet, other areas may be provided.

The synchronization code area F1 stores data for synchronizing communication with the controlled device 2.

The ID code area F2 is an area where an ID for identifying a communication target device is stored, and specifically, an ID of the controlled device 2 is stored. Further, an ID for specifying the controller 1 that is a device of a transmission source may be further stored in the ID code area F2.

The hopping pattern area F3 is an area where a code for specifying a transition pattern of the channel CH in frequency hopping is stored. For example, when N types of transition patterns (hereinafter, referred to as “hopping patterns”) of the channel CH are provided, any numerical value from 1 to N is stored in the hopping pattern area F3. Several types to several tens of types of transition patterns of the channel CH may be prepared. As the number of the prepared transition patterns increases, the possibility that the communication collision can be avoided increases.

The hopping pattern may be, for example, a pattern in which channels CH0 to CH35 are selected in an ascending order or a descending order, or may be a pattern in which the channel CH21, the channel CH4, the channel CH31, the channel CH18, and the channel CH26 are sequentially selected randomly or pseudo-randomly after a channel CH0 is selected.

In the random pattern, a predetermined random pattern may be repeated, or the channels CH may be sequentially selected completely randomly.

In addition to the random pattern, every fifth channel CH from the channel CH0 may be selected. For example, the channels may be sequentially selected in the order of the channel CH0, the channel CH5, the channel CH10, . . . , the channel CH35, the channel CH4, the channel CH9, . . . .

Alternatively, a hopping pattern in which 18 channels CH from the channel CH0 to the channel CH17 are randomly shifted/transitioned to correspond to the presence of broadband interference waves, and a hopping pattern in which 18 channels CH from the channel CH18 to the channel CH35 are randomly shifted/transitioned may be provided. Further, these hopping patterns may be appropriately selected and used depending on the presence of interference waves. For example, when there are relatively wide band interference waves that affect most of the channels CH0 to CH17, the latter hopping pattern using the channels CH18 to CH35 is used.

The channel valid/invalid information area F4 stores a valid flag or an invalid flag for each channel CH used for frequency hopping. For example, when 36 channels CH are used for frequency hopping, flag information consisting of 36 bits is stored in the channel valid/invalid information area F4.

The control information for the controlled device 2 is stored in the control data area F5. The control information may be, for example, data indicating a voltage applied to the driving unit 11 of the control target, or data indicating the driving amount (for example, angle information) of the driving unit 11 of the control target.

Further, the control data area F5 includes instruction information for causing the controlled device 2 to perform a predetermined operation. For example, when the controlled device 2 is provided with a camera device, the code information for instructing the camera device to perform an imaging operation is stored in the control data area F5.

A redundancy code for detecting errors in each data included in a message packet is stored in the check area F6. For example, the check area F6 may store a redundancy code for detecting only errors in control data, or may store a redundancy code for detecting errors in other areas. Further, error correction may be performed regardless of an error checking method.

### 2-2. Return Data

FIG. 4 shows an example of a structure of a message packet in a return data Dr from the controlled device 2, which is the reception data received by the controller 1 from the controlled device 2.

The return data Dr includes a synchronization code area F11, an ID code area F12, a hopping pattern area F13, a first RSSI value area F14, a second RSSI value area F15, a telemetry data area F16, and a check area F17. Although FIG. 4 shows a part of the data structure of the message packet, other areas may be provided.

The synchronization code area F11 stores data for synchronizing communication between the controller 1 and the controlled device 2.

The ID code area F12 is an area where an ID for identifying the controller 1, an ID for identifying the controlled device 2, or the like is stored.

The hopping pattern area F13 is an area where a code for specifying a hopping pattern in frequency hopping is stored.

The first RSSI value area F14 is an area where the RSSI value measured for the channel CH used for transmission and reception of the corresponding message packet is stored. Here, the channel CH selected by the controller 1, which is the channel CH used for transmission and reception, is referred to as “selected channel CHs.”

The first RSSI value area F14 stores, as the RSSI value (first RSSI value) for the selected channel CHs, the radio wave strength information obtained when the previous transmission data Ds was received.

The second RSSI value area F15 is an area where the RSSI value measured for a certain channel CH during a time period in which the message packet is not transmitted or received is stored. Here, the channel CH as the measurement target of the second RSSI value is referred to as “measurement channel CHm.”

The second RSSI value may be considered as a numerical value indicating the noise level measurement result. Therefore, the second RSSI value becomes lower as the communication environment becomes better.

The selected channel CHs and the measurement channel CHm may be the same channel CH or may be different channels CH. In this example, a case in which the selected channel CHs and the measurement channel CHm are the same channel CH will be described.

The telemetry data area F16 is an area where information such as voltage values or current values measured in the controlled device 2, or a remaining battery power is stored as telemetry information.

The check area F17A is an area where the redundancy code for detecting errors in each data included in a message packet is stored.

### 3. RSSI Value Measurement Timing

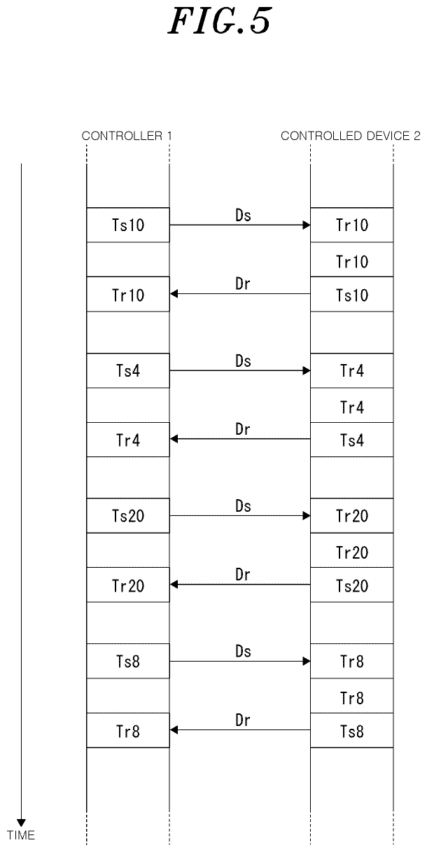

The state transition of the controller 1 and the controlled device 2 depending on the communication, and the RSSI value measurement timing in the controlled device 2 will be described with reference to FIG. 5.

The period in which the communication state of the antenna is a reception state is defined as a reception period Tr, and the period in which the communication state of the antenna is a transmission state is defined as the transmission period Ts. Further, the period in which the radio waves in the frequency band corresponding to the channel CH0 can be received is defined as a reception period Tr0, and the period in which the radio waves in the frequency band corresponding to the channel CH10 can be received is defined as a reception period Tr10.

Similarly, the period in which radio waves in the frequency band corresponding to the channel CH0 can be transmitted is defined as a transmission period Ts0, and the period in which radio waves in the frequency band corresponding to the channel CH10 can be transmitted is defined as a transmission period Ts10.

As shown in FIG. 5, the control part 5 of the controller 1 prepares the transmission period Ts10 in which the antenna 3 is controlled to the transmission state corresponding to the channel CH10 selected based on the hopping pattern, and transmits the transmission data Ds to the controlled device 2.

On the other hand, the control part 10 of the controlled device 2 in the same period prepares the reception period Tr10 in which the antenna 8 is controlled to a reception state corresponding to the channel CH10. Accordingly, the control part 10 receives the transmission data Ds via the receiver 9R. Further, the control part 10 obtains the RSSI value at the time of receiving the transmission data Ds as the first RSSI value.

Next, communication downtime exists until the controlled device 2 returns the message packet to the controller 1. Using this time, the control part 10 of the controlled device 2 prepares the reception period Tr10 in which the antenna 8 is controlled to the reception state corresponding to the measurement channel CHm (the channel CH10 in this example) again, and acquires the second RSSI value. The second RSSI value acquired in this case is determined by the noise level caused by the communication between other devices.

When the communication downtime ends, the control part 10 of the controlled device 2 prepares the transmission period Ts10 in which the antenna 8 is controlled to a transmission state corresponding to the channel CH10 in order to return the message packet to the controller 1. Accordingly, the control part 10 transmits the return data Dr to the controller 1 via the transmitter 9S. The return data Dr includes both the first RSSI value and the second RSSI value.

The control part 5 of the controller 1 in the same period prepares the reception period Tr10 in which the antenna 3 is controlled to a reception state corresponding to the channel CH10. Accordingly, the control part 5 receives the return data Dr via the receiver 4R.

The transmission and reception of the transmission data Ds and the transmission and reception of the return data Dr are completed between the transmission period Ts in which the control part 5 of the controller 1 controls the antenna 3 to the transmission state and the reception period Tr in which the antenna 3 is controlled to the reception state.

After the transmission and reception of the transmission data Ds and the return data Dr are completed, the control part 5 of the controller 1 and the control part 10 of the controlled device 2 select a next channel CH as the selected channel CHs based on the hopping pattern. In the example shown in FIG. 5, the channel CH4 is selected as the selected channel CHs and, then, the channel CH20 and the channel CH8 are selected in the same manner.

The control part 5 of the controller 1 acquires the second RSSI value from the received return data Dr. As shown in FIG. 5, when the transmission and reception of the transmission data Ds and the transmission and reception of the return data Dr are repeated between the controller 1 and the controlled device 2, the data of the second RSSI value for each channel CH is accumulated in the controller 1.

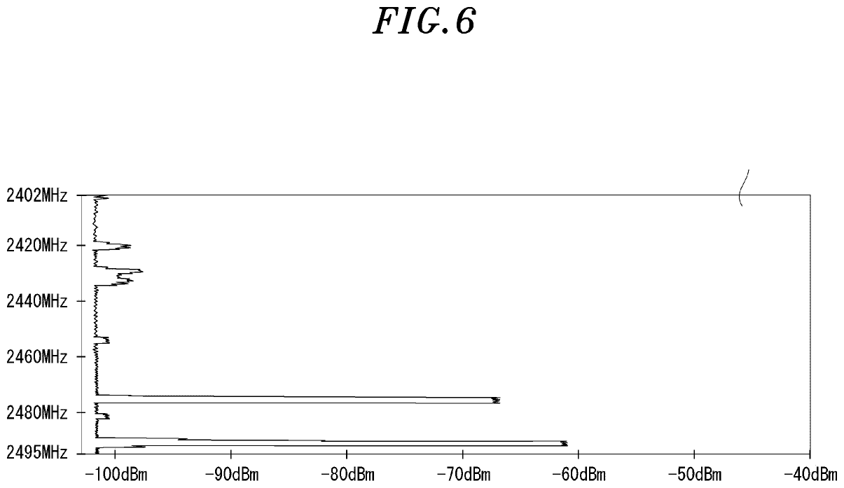

The control part 5 uses the accumulated second RSSI values to realize spectrum display shown in FIG. 6 on the display part 7.

In the display shown in FIG. 6, the vertical axis represents a frequency and the horizontal axis represents an RSSI value, and the noise level for each channel CH (for each frequency) is visualized.

As shown in FIG. 6, the frequency bands with high RSSI values are likely to be used for communication in other devices, and are not suitable for use in communication between the controller 1 and the controlled device 2.

The control part 5 determines whether or not to use each channel CH based on the frequency bands, and reflects the determination result in next selection of the selected channel CHs.

### 5. Processing Flow

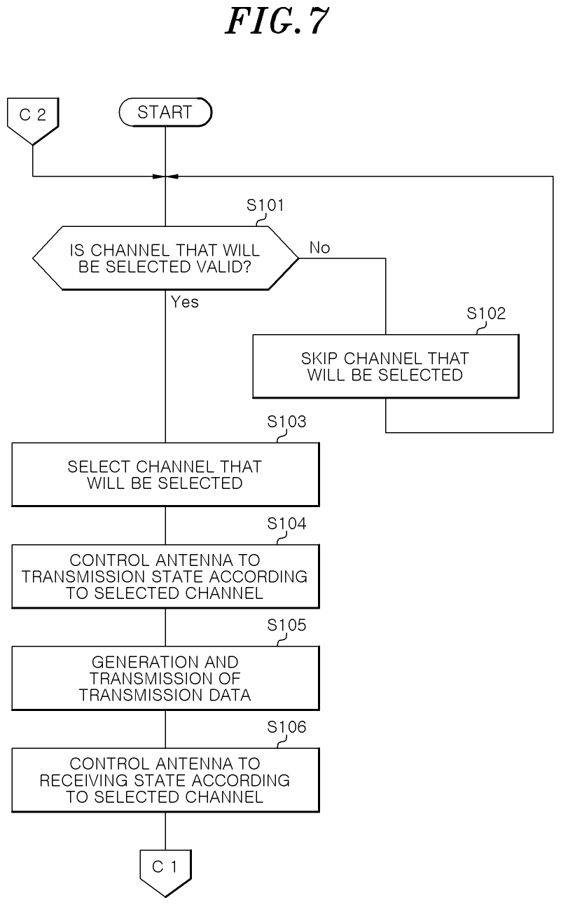

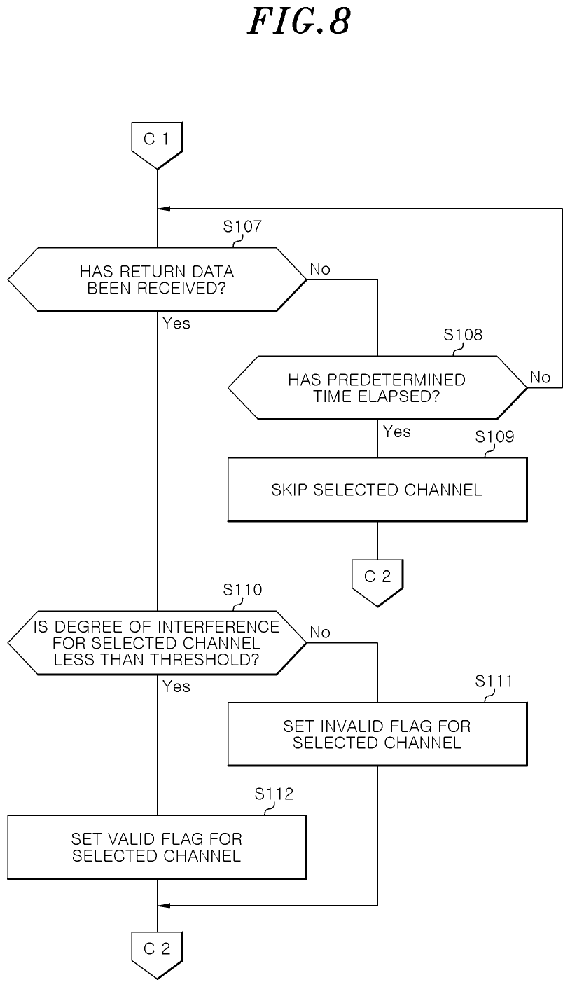

An example of the flow of processing executed by the control part 5 of the controller 1 is shown in FIGS. 7 and 8.

It is assumed that the hopping pattern selection and the processing of sharing the selected hopping pattern with the controlled device 2 are completed before the execution of the loop processing of FIGS. 7 and 8.

In FIGS. 7 and 8, the connection of the processes between FIGS. 7 and 8 are indicated by connectors C1 and C2.

In step S101, the control part 5 determines whether or not the channel CH to be selected next is valid depending on the hopping pattern.

When the invalid flag is set for the channel CH to be selected next due to the presence of interference waves or the like, it is determined that the channel CH to be selected next is not valid, and the control part 5 skips the channel CH to be selected next in subsequent step S102 and returns to the processing of step S101.

On the other hand, when it is determined that the invalid flag is not set for the channel CH to be selected and the channel CH to be selected is valid, the control part 5 selects the channel CH to be selected as the selected channel CHs in step S103.

In step S104, the control part 5 controls the antenna 3 to a transmission state in which the radio waves of the frequency corresponding to the selected channel CHs can be transmitted.

In step S105, the control part 5 generates the transmission data Ds and transmits it to the controlled device 2. The transmission data Ds generated in this case stores valid/invalid information for each channel CH corresponding to an invalid flag that is set or canceled in step S111 or step S112 to be described later. Further, the transmission data Ds includes control information for controlling the controlled device 2.

In order to receive the return data Dr from the controlled device 2, the control part 5 controls the antenna 3 to a receiving state in which the radio waves of a frequency corresponding to the selected channel CHs can be received in step S106. Further, the control part 5 may prepare a standby time corresponding to a predetermined period of downtime before the processing of step S106.

Next, the control part 5 determines whether or not the return data Dr has been received in step S107 of FIG. 8. When it is determined that the return data Dr has not been received, the control part 5 determines whether or not a predetermined time has elapsed in step S108. The case where a predetermined period of time has elapsed without receiving the return data Dr indicates, for example, the case where the return data Dr from the controlled device 2 cannot be properly received due to the presence of interference waves. In this case, the control part 5 newly transmits the transmission data Ds from the controller 1 using the next selected channel CHs selected based on the hopping pattern.

Therefore, when it is determined in step S108 that the predetermined time has elapsed, the control part 5 skips the selected channel CHs in preparation for the transmission of the next transmission data Ds in step S109 and returns to step S101. Accordingly, whether or not the channel CH to be selected next is valid is determined based on the hopping pattern.

On the other hand, when it is determined that the return data Dr has not been received and the predetermined time has not elapsed, the control part 5 returns to step S107 and checks whether or not the return data Dr has been received.

When it is determined that the return data Dr has been received, the control part 5 proceeds to step S110.

Although it will be described in detail later, the received return data Dr includes the first RSSI value that is the radio field strength information on the selected channel CHs measured at the time of transmitting and receiving the transmission data Ds, and the second RSSI value that is the radio field strength information on the noise level for the measurement channel CHm (the same channel as the selected channel CHs in this example).

In step S110, the control part 5 determines whether or not the degree of interference for the selected channels CHs is less than a threshold. Specifically, the control part 5 quantifies the degree of interference by comparing the threshold with the difference obtained by subtracting the second RSSI value for the selected channels CHs from the first RSSI value for the selected channels CHs.

If the difference is smaller than or equal to the threshold, the noise level is close to the reception level obtained when the transmission data Ds is received by the controlled device 2 and, thus, it is determined that the environment does not allow appropriate communication. In this case, the control part 5 determines in step S110 that the degree of interference is greater than or equal to the threshold, and sets an invalid flag for the selected channel CHs in subsequent step S111.

Thus, the selected channels CHs is prevented from being selected again in subsequent frequency hopping.

In step S111, the valid flag may be canceled instead of setting the invalid flag.

On the other hand, when the difference is greater than the threshold, it is determined that the environment allows satisfactory reception of the transmission data Ds. Therefore, the control part 5 determines in step S110 that the degree of interference is less than the threshold, and sets a valid flag for the selected channel CHs in subsequent step S112. Further, in step S112, the invalid flag may be canceled instead of setting the valid flag.

Even if the noise level is high, when the radio field strength for the transmission data Ds is relatively high, the difference becomes large, so that the channel CH is determined to be valid.

On the other hand, even if the noise level is low, when the radio field strength for the transmission data Ds is low, the difference value becomes small, so that the channel CH is determined to be invalid.

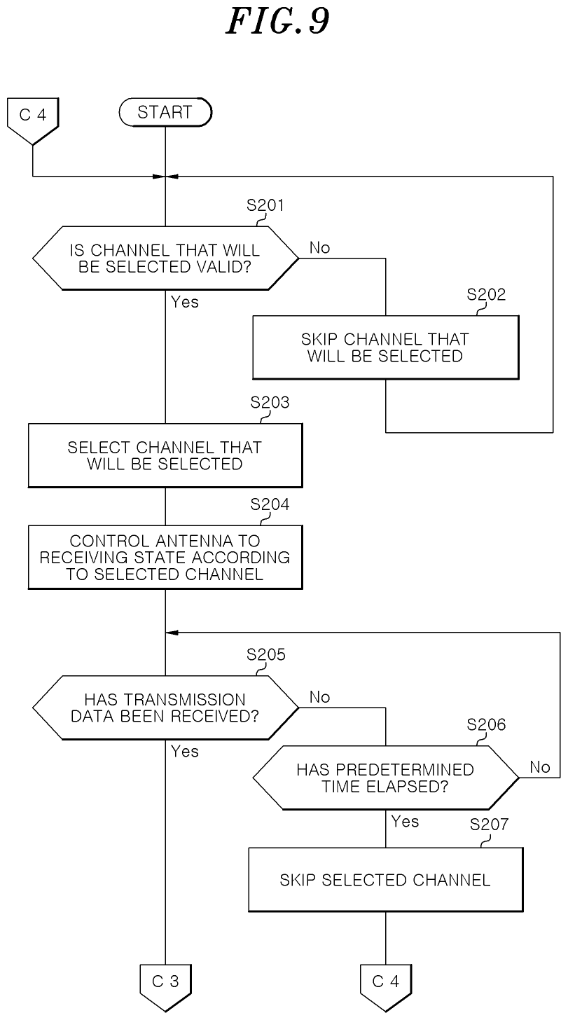

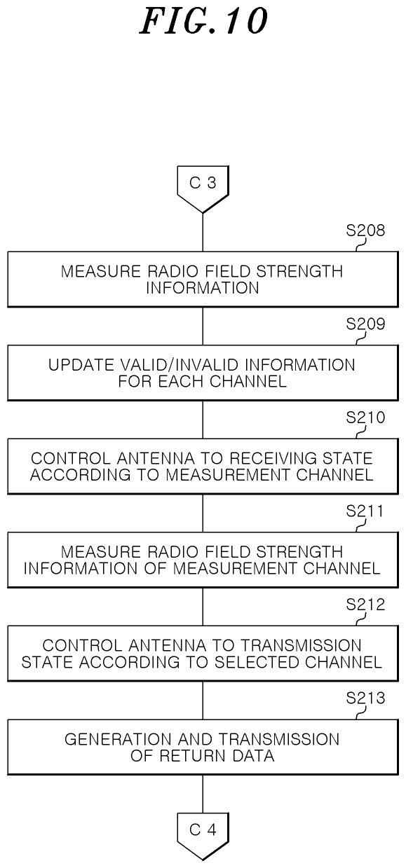

Next, FIGS. 9 and 10 show examples of processing executed by the control part 10 of the controlled device 2 in response to the control of the control part 5 of the controller 1 shown in FIGS. 7 and 8. In FIGS. 9 and 10, the connection of the processes between FIGS. 9 and 10 is indicated by connectors C3 and C4.

In step S201, the control part 10 of the controlled device 2 determines whether or not the channel CH to be selected is valid. When an invalid flag is set for the channel CH to be selected, the control part 10 determines that the channel CH to be selected is not valid, and skips the channel CH to be selected in step S202.

On the other hand, when it is determined that the channel CH to be selected is valid, the control part 10 selects the channel CH to be selected as the selected channel CHs in step S203.

In step S204, the control part 10 controls the antenna 8 to a reception state corresponding to the selected channel CHs.

In step S205, the control part 10 determines whether or not the transmission data Ds has been received.

When it is determined that the transmission data Ds has not been received, the control part 10 determines whether or not a predetermined time has elapsed in step S206. The case where a predetermined period of time has elapsed without receiving the transmission data Ds indicates, for example, the case where the transmission data Ds from the controller 1 cannot be properly received due to the presence of interference waves. In this case, the control part 10 newly transmits the transmission data Ds from the controller 1 using the next selected channel CHs selected based on the hopping pattern.

Therefore, when it is determined in step S206 that the predetermined time has elapsed, the control part 10 skips the selected channel CHs in preparation for the reception of the next transmission data Ds in step S207, and returns to step S201. Accordingly, whether or not the channel CH to be selected next is valid is determined based on the hopping pattern.

On the other hand, when it is determined that the transmission data Ds has not been received and the predetermined time has not elapsed, the control part 10 returns to step S205 and checks whether or not the transmission data Ds has been received.

When it is determined in step S205 that the transmission data Ds has been received, the control part 10 measures the radio field strength information obtained at the time when the transmission data Ds is received in step S208 of FIG. 10. Accordingly, the first RSSI value for the selected channel CHs is obtained.

The received transmission data Ds includes the valid/invalid information for each channel CH. Accordingly, the control part 10 updates the valid/invalid information for each channel CH in step S209.

In step S210, the control part 10 controls the antenna 8 to a reception state corresponding to the measurement channel CHm. In this example, the selected channel CHs and the measurement channel CHm are the same channel CH, so that the switching to the reception state corresponding to the measurement channel CHm may not be necessary.

In step S211, the control part 10 measures the radio field strength information of the measurement channel CHm. Accordingly, the second RSSI value for measurement channel CHm is acquired.

In step S212, the control part 10 controls the antenna 8 to a transmission state corresponding to the selected channel CHs.

The control part 10 generates the return data Dr and transmits it to the controller 1 in step S213. The generated return data Dr stores the first RSSI value for the selected channel CHs and the second RSSI value for the measurement channel CHm. Further, various types of telemetry information such as a remaining battery power and the like are also stored in the return data Dr.

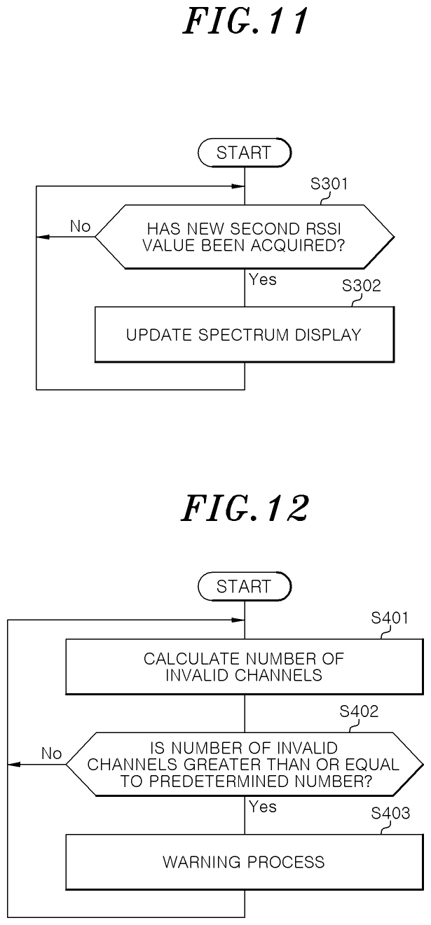

The control part 5 of the controller 1 executes the series of processes shown in FIGS. 7 and 8 and other processes simultaneously. The processes that are executed by the control part 5 of the controller 1 simultaneously with the processes shown in FIGS. 7 and 8 will be described with reference to the drawings. FIG. 11 shows an example of processing executed by the control part 5 of the controller 1 in order to display the spectrum shown in FIG. 6 on the display part 7 of the controller 1.

The control part 5 determines whether or not a new second RSSI value has been acquired from the controlled device 2 in step S301. When it is determined that the second RSSI value has not been acquired, the control part 5 performs the processing of step S301 again.

On the other hand, when it is determined that a new second RSSI value has been acquired, the control part 5 updates the spectrum display on the display part 7 in step S302. By executing the processes shown in FIG. 11 every few milliseconds or seconds, for example, the spectrum display showing the latest noise level for each frequency is displayed on the display part 7.

For example, when broadband interference waves are present, the control part 5 of the controller 1 determines that it is unlikely to perform appropriate control, and executes a warning process for notifying an operator thereof.

FIG. 12 shows an example of processing executed by the control part 5 in relation to the warning process.

In step S401, the control part 5 calculates the number of invalid channels determined to be invalid.

In step S402, the control part 5 determines whether or not the number of invalid channels is greater than or equal to a predetermined number. The determination threshold used here is set, for example, depending on the number of channels used in frequency hopping.

Specifically, the determination threshold may be determined such that the number of valid channels becomes greater than or equal to a predetermined number, or may be determined based on the ratio of invalid channels to the total number of channels.

When it is determined that the number of invalid channels is less than the predetermined number, the control part 5 returns to step S401 without performing the warning process in step S403.

On the other hand, when it is determined that the number of invalid channels is greater than or equal to the predetermined number, the control part 5 performs the warning process in step S403.

The warning process may be realized in various manners.

For example, the warning process may be realized by displaying warning display for urging landing or stopping on the display part 7 of the controller 1, or may be realized by outputting predetermined warning sound or warning voice for urging landing from a speaker of the controller 1.

Alternatively, the notification of the warning process may be realized by appealing to an operator's sense of touch by vibrating a vibrator built in the controller 1.

Further, a process for safely stopping the controlled device 2 may be performed simultaneously with the warning process. For example, when the controlled device 2 is a flying object such as a drone or the like, the controlled device 2 may be urged to safely land on the ground near an operator by automatically driving the driving part 11 of the controlled device 2 such that the controlled device 2 become close to an operator.

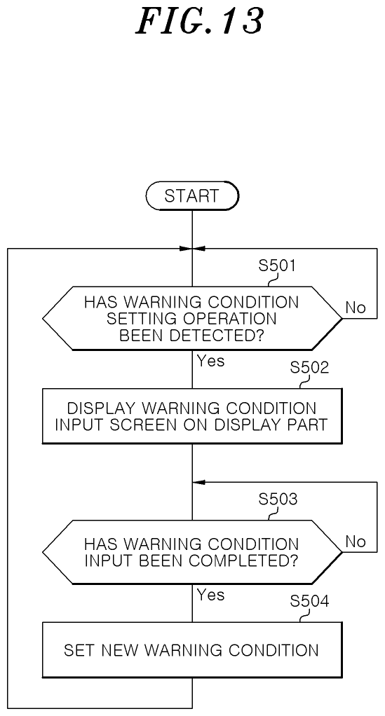

Further, the warning condition (the condition used in step S402 in FIG. 12) that is the condition for activating the warning process may be appropriately set by an operator or the like. FIG. 13 shows an example of warning condition setting executed by the control part 5.

In step S501, the control part 5 determines whether or not the warning condition setting operation has been detected. The warning condition setting operation includes an operation of pressing a specific button, an operation of selecting a specific menu, or the like. Alternatively, when the manipulation can be performed using a voice input, a specific voice input operation may be detected as the warning condition setting operation.

The control part 5 periodically executes the processing of step S501 until the warning condition setting operation is detected.

When it is determined that the warning condition setting operation has been detected, the control part 5 causes the display part 7 to display a warning condition input screen in step S502.

In step S503, the control part 5 determines whether or not the warning condition input has been completed. The warning condition input is completed by, for example, pressing a completion button or a setting button.

When it is determined that the warning condition input has not been completed, the control part 5 repeats the processing of step S503. When a cancel operation is detected, the control part 5 returns to the processing of step S501.

On the other hand, when it is determined that the warning condition input has been completed, the control part 5 sets an inputted new warning condition in step S504.

The warning condition set here may be the number of invalid channels, the ratio of invalid channels to the total number of channels, or the level of the radio wave strength of the interference wave.

Further, the threshold used in step S110 in FIG. 8 may be set as the threshold for determining an invalid channel and a valid channel together with the setting of the warning condition.

### 6. Second Embodiment

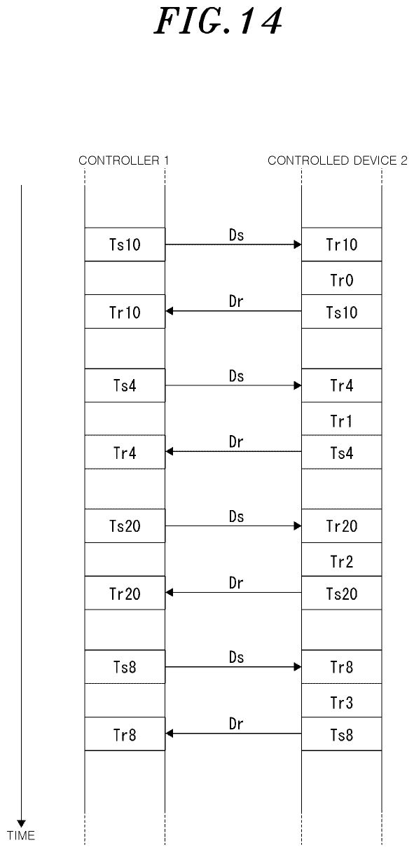

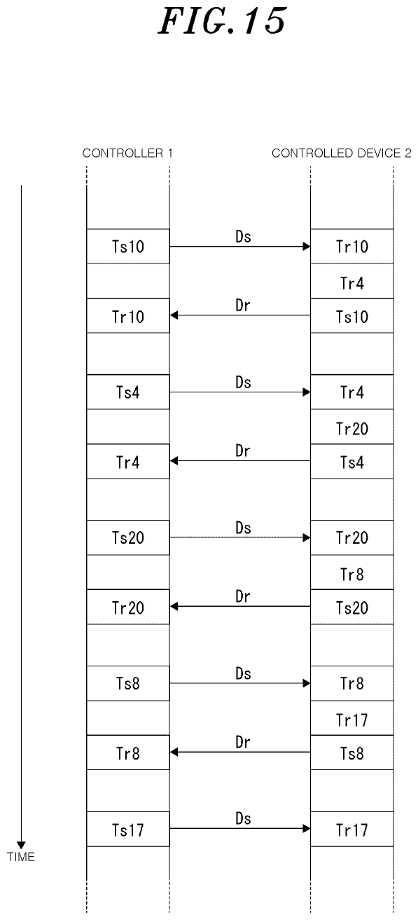

A second embodiment is an example in which the measurement channel CHm is different from the selected channel CHs. FIG. 14 shows the relationship between the selected channel CHs and the measurement channel CHm in the present embodiment.

As shown in FIG. 14, the selection order of the selected channels CHs is the same as that in FIG. 5 in the first embodiment. However, the measurement channel CHm where the radio field strength information is acquired between the reception of the transmission data Ds and the transmission of the return data Dr in the controlled device 2 is selected in an ascending order from the channel CH0 regardless of the selected channel CHs.

The processing executed by the control part 10 of the operated device 2 in the present embodiment is similar to that shown in FIGS. 9 and 10.

However, the radio field strength information measured in step S208 is the first RSSI value for the selected channel CHs.

Further, the radio field strength information measured in step S211 is the second RSSI value for the measurement channel CHm different from the selected channel CHs.

Specifically, the selected channel CHs is the channel CH10, and the measurement channel CHm is the channel CH0.

In this case, the first RSSI value for the channel CH10 and the second RSSI value for the channel CH0 are stored in the return data Dr generated in step S213.

Accordingly, the control part 5 of the controller 1 determines whether or not the degree of interference with respect to the selected channel CHs is less than the threshold in the processing of step S110 shown in FIG. 8.

The degree of interference for the selected channel CHs used in this process is the degree of interference for the channel CH10, and the first RSSI value for the channel CH10 stored in the return data Dr received in previous step S107 and the second RSSI value for the channel CH10 stored as the second RSSI value for the measurement channel CHm in the return data Dr received in previous step S108 are used.

In other words, unlike the first embodiment, the processing of step S110 cannot be performed using the first RSSI value and the second RSSI value included in one return data Dr.

Therefore, the control part 5 of the controller 1 needs to store the second RSSI value for the measurement channel CHm included in the return data Dr received in step S108 in the storage part of the controller 1 until the processing of next and subsequent step S110 that requires the data is executed.

### 7. Third Embodiment

A third embodiment is an example in which the channel CH to be selected after the current selected channel CHs is set to the measurement channel CHm based on the hopping pattern. FIG. 15 shows the relationship between the selected channel CHs and the measurement channel CHm in the present embodiment.

As shown in FIG. 15, the selection order of the selected channels CHs is the same as that in FIG. 5 in the first embodiment. However, the measurement channel CHm where the radio field strength information is acquired between the reception of the transmission data Ds and the transmission of the return data Dr in the controlled device 2 is the channel CH to be selected next.

For example, when the selected channel CHs is changed to the channel CH10, the channel CH4, and the channel CH20, the measurement channel CHm, which is the second RSSI value measurement target in a state where the channel CH10 is selected as the selected channel CHs, is the channel CH4 to be selected next.

In other words, the noise level of the channel CH4 to be selected next is measured in advance.

Further, in this case, when the controller 1 receives the return data Dr, the control part 5 may determine the invalidity of the selected channel CHs using the first RSSI value for the selected channel CHs included in the return data Dr, and may also determine the invalidity of the measurement channel CHm using the second RSSI value for the measurement channel CHm included in the return data Dr.

Accordingly, it is possible to appropriately determine whether to select the channel CH to be selected next or skip it.

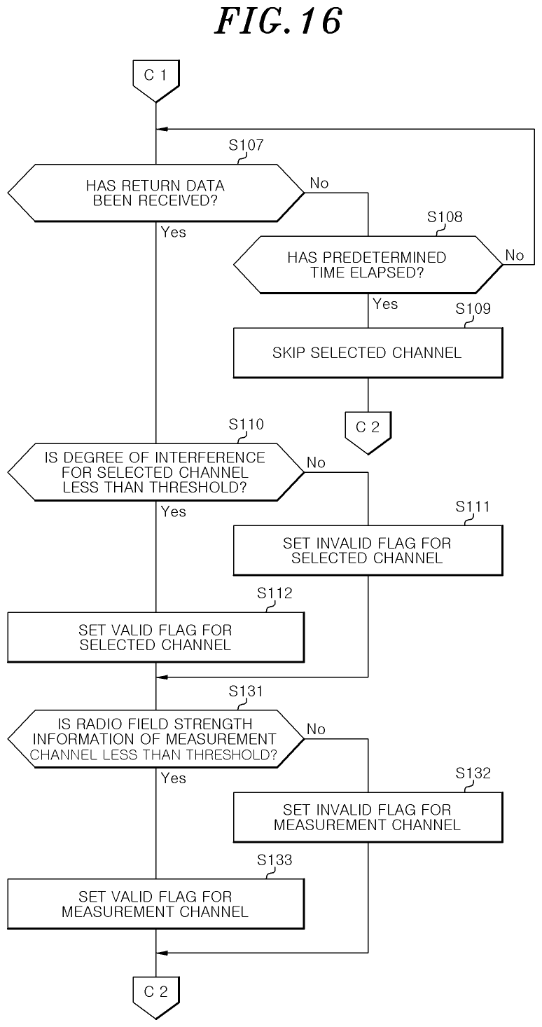

An example of processing executed by the control part 5 is shown in FIG. 16.

FIG. 16 shows the processing subsequent to FIG. 7 in the first embodiment, which are partially different from the processing shown in FIG. 8.

Therefore, in FIG. 16, the same step numbers will be used for the same processes as those in FIG. 8, and the description thereof will be simplified appropriately.

After it is determined in step S107 that the return data Dr has been received, the control part 5 determines in step S110 whether or not the degree of interference with respect to the selected channel CHs is less than the threshold.

Then, the control part 5 sets a valid flag or an invalid flag for the selected channel CHs in step S111 or step S112 depending on the determination result in step S110.

Next, in step S131, the control part 5 determines whether or not the radio field strength information of the measurement channel CHm, that is, the second RSSI value, is less than the threshold. The threshold used in step S131 is different from the threshold used in step S110.

As described above, the second RSSI value is the radio field strength information measured in a period in which the transmission data Ds or the return data Dr is not transmitted and received, and indicates the noise level.

When it is determined that the second RSSI value is greater than or equal to the threshold, the control part 5 sets an invalid flag to the measurement channel CHm in step S132.

On the other hand, when it is determined that the second RSSI value is less than the threshold, the control part 5 sets a valid flag for the measurement channel CHm in step S133.

Accordingly, the valid flag or the invalid flag is set for the channel CH to be selected next.

Then, in step S101 of FIG. 7, the control part 5 determines the flag of the channel CH to be selected next, and determines whether to skip it or not.

The determination process in step S131 is a process of determining whether to validate or invalidate the channel CH different from the current selected channel CHs.

Therefore, there is a possibility that the invalid flag is currently set for the measurement channel CHm as a measurement target.

In this case, the determination process in step S131 may also be a process of determining whether or not to set the channel CH that is currently an invalid channel as a valid channel CH.

In other words, by performing the series of processes shown in FIGS. 7 and 16, the channel CH that was once invalidated due to the presence of interference waves can be validated again.

Therefore, it is possible to reduce the possibility that appropriate frequency hopping cannot be performed due to an excessive increase in the number of invalid channels.

In the example shown in FIG. 16, when the second RSSI value for the invalid channel is less than the threshold, a process of immediately changing an invalid channel to a valid channel is executed in step S133.

However, the present disclosure is not limited thereto, and the second RSSI value for one invalid channel may be obtained a predetermined number of times, and the one invalid channel may be changed to a valid channel when all the second RSSI values are less than the threshold. In other words, it is possible to avoid frequent changes in the determination result for a specific channel between an invalid channel and a valid channel due to the influence of unstable interference waves.

### 8. Modifications

Modifications of the above examples will be described.

The invalidation determination for the measurement channel CHm was performed using only the second RSSI value as described with reference to FIG. 16. However, the invalidation determination in step S110 in FIG. 8 may also be performed for the selected channel CHs using only the second RSSI value without using the first RSSI value. In other words, the invalidation determination of each channel CH may be performed using only the second RSSI value corresponding to the measurement result of the noise level.

In this case, the measurement of the radio field strength information in step S208 in FIG. 10 is not required.

In the example shown in FIG. 3, code information for specifying the hopping pattern is stored in the hopping pattern area F3 of the message packet as the transmission data Ds.

In addition, the information on the channel CH to be selected may be stored in the hopping pattern area F3. Further, in consideration of the possibility that the channel CH to be selected next cannot be used due to the interference waves, or the like, the information on multiple channels may be stored in the hopping pattern area F3 in the order of scheduled selection.

For example, in the example in which the channels CH are selected in the order shown in FIG. 5, the information on the channel CH4, the channel CH20, and the channel CH8 may be stored in that order in the hopping pattern area F3 of the transmission data Ds transmitted from the controller 1 during the transmission period Ts10.

Accordingly, even if the controlled device 2 does not recognize all the hopping patterns, the frequency hopping can be performed a predetermined number of times.

In the above examples, the second RSSI value for one measurement channel CHm is measured between the reception period Tr in which the controlled device 2 receives the transmission data Ds and the transmission period Ts in which the return data Dr is transmitted in response thereto.

The present disclosure is not limited thereto, and the second RSSI values for a plurality of measurement channels CHm may be measured between the reception period Tr and the transmission period Ts.

In this case, the second RSSI values measured for the plurality of measurement channels CHm may be stored in the return data Dr transmitted during the transmission period Ts.

Accordingly, the controller 1 may perform validity determination or invalidity determination for the plurality of measurement channels CHm based on the plurality of second RSSI values.

Further, an example in which the second RSSI value for the measurement channel CHm is measured between the reception of the transmission data Ds and the transmission of the return data Dr has been described.

The present disclosure is not limited thereto, and the second RSSI value for the measurement channel CHm may be measured during the period between the transmission of the return data Dr and the reception of the next transmission data Ds.

Further, the second RSSI value for different measurement channels CHm may be determined in both periods between the reception of the transmission data Ds and the transmission of the return data Dr, and between the transmission of the return data Dr and the reception of the next transmission data Ds.

Accordingly, in the case of determining the invalidity of the channel CH using only the second RSSI value, a larger number of channels CH can be determined.

Therefore, it is possible to quickly determine the channel CH that should be invalidated as an invalid channel, and the possibility that the transmission data Ds or the return data Dr will be transmitted and received using the channel CH capable of performing satisfactory communication can be increased.

### 9. Summary

As described above, the control apparatus as the controller 1 includes the control part 5 for determining the selection order of the channels CHs in the frequency hopping, the transmitter 4S for performing transmission of the transmission data Ds at a frequency corresponding to the selected channel CHs selected based on the selection order, and the receiver 4R for performing, in response to the transmission, reception of the reception data (the return data Dr) from the communication target device (the controlled device 2) at a frequency corresponding to the selected channel CHs.

Further, the reception data (the return data Dr) includes the radio field strength information on the measurement channel CHm of the measurement target as the channel CH used for the frequency hopping.

For example, the controlled device 2 as the communication target device is a remote control target device, e.g., a multicopter such as a drone, or a radio control model. The control apparatus (the controller 1) is a controller operated by a user to control the remote control target device.

In this case, the control information (posture control information) for controlling the controlled device 2 is transmitted from the transmitter 4S. Accordingly, the control results or various types of telemetry information are transmitted from the controlled device 2 to the receiver 4R.

By using the transmission and reception of such information, the remote control of the controlled device 2 using the controller 1 can be performed.

The transmission and reception thereof are normal transmission and reception operations for remotely controlling the controlled device 2. With this configuration, the radio field strength information can be received from the controlled device 2 during the normal transmission and reception.

Therefore, it is not necessary to fly another device to check radio wave interference or to fly the controlled device 2 for pre-checking. In other words, it is possible to reduce or eliminate the checking time for measuring the communication environment.

Further, by obtaining the radio field strength information on the channel CHs that is constantly used for frequency hopping in a normal usage state, it is possible to adaptively change the selected channel CHs for frequency hopping, and also possible to stably operate the controlled device 2. Particularly, when the controlled device 2 is a device that flies in the air, the possibility of losing control of the device can be reduced and the flight safety can be improved.

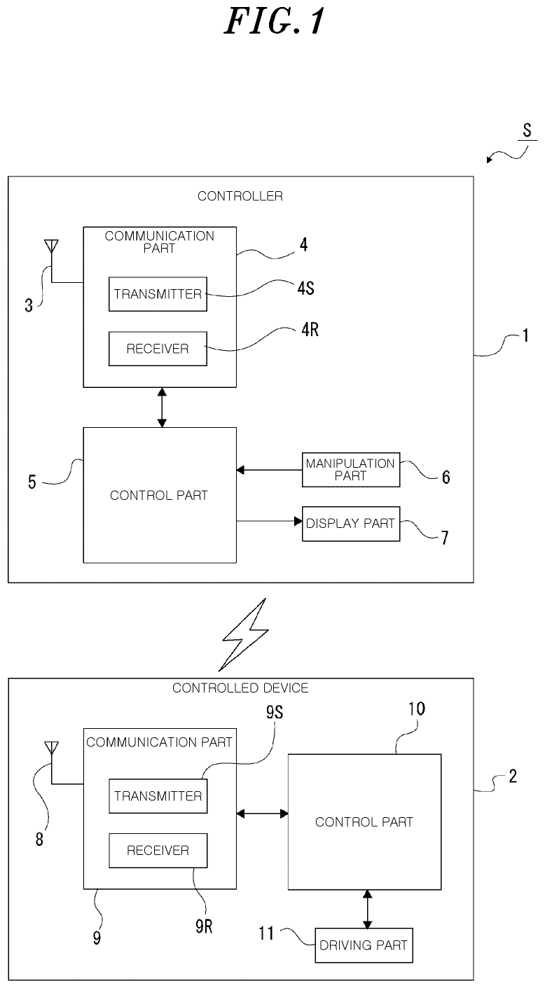

Since only the radio field strength information on the measurement channel CHm or the radio field strength information on the selected channel CHs is included in the reception data (the return data Dr), it is possible to measure the radio field strength information during a short downtime in which the communication is not performed between normal transmission and normal reception. In other words, it is easy to acquire the radio field strength information in a normal usage state. As described in the configuration of the communication system S with reference to FIG. 1, the reception data Ds transmitted by the transmitter 4S in the control apparatus as the controller 1 may include the control information (data stored in the control data area F5) for controlling the posture or operation of the communication target device (the controlled device 2), and the reception data (the return data Dr) received by the receiver 4R may include the telemetry information (data stored in the telemetry data area F16) on the communication target device (the controlled device 2) and the radio field strength information (data stored in the second RSSI value area F15).

Therefore, the radio field strength information is received during normal transmission and reception for controlling the movement of the controlled device 2.

Accordingly, the radio wave interference that makes the controlled device 2 uncontrollable can be checked, and appropriate frequency hopping can be performed.

As described with reference to FIGS. 5, 8, and the like, the reception data (the return data Dr) received by the receiver 4R of the control apparatus as the controller 1 may include the radio field strength measured after the transmission corresponding to the reception.

Accordingly, the communication target device (the controlled device 2) performs the reception of data, the measurement of the radio field strength information, and the transmission of data including the information.

Hence, it is not required to separately perform transmission and reception for transferring the radio field strength information to the control apparatus (the controller 1), and the communication efficiency can be improved.

Further, by receiving the reception data (the return data Dr) including the radio field strength information measured between transmission and reception corresponding to each other, the control apparatus (the controller 1) can receive the most recently measured radio field strength information on the measurement channel CHm, and the selected channel CHs for frequency hopping can be selected based on the latest radio field strength information.

Thus, the possibility that a satisfactory communication state is maintained can be increased.

As described with reference to FIGS. 5, 8, and the like, in the control apparatus as the controller 1, the measurement channel CHm that is the measurement target of the radio field strength information may be the current selected channel CHs.

For example, in the case of selecting a certain channel CH and performing transmission and reception, the radio field strength information on the channel CH is measured between the transmission and the reception, and the radio field strength information (the second RSSI value) is included in the reception data (the return data Dr).

Specifically, the communication target device (the controlled device 2) stands by in a reception mode in the selected channel CHs to receive the transmission data Ds from the control apparatus (the controller 1), and receives the transmission data Ds. Then, the reception mode is continued without changing the selected channel CHs to measure the radio field strength information on the selected channel CHs. After the radio field strength information is measured, the mode is switched to a transmission mode without changing the selected channel CHs, and the data including the radio field strength information is transmitted to the control apparatus (the controller 1).

Therefore, in the communication target device (the controlled device 2), the data reception, the measurement of the radio field strength information, and the data transmission can be performed without changing the channel CH, and the processing load can be reduced.

As described in the second and third embodiments with reference to FIGS. 14, 15, and the like, in the control apparatus as the controller 1, the measurement channel CHm that is the measurement target of the radio field strength information may be the channel CH other than the current selected channel CHs.

Accordingly, it is possible to obtain the radio field strength information on a desired channel CH as well as the current selected channel CHs in frequency hopping.

Hence, it is possible to obtain information that helps the selection of the selected channel CHs in frequency hopping.

As described in the third embodiment with reference to FIGS. 15, 16, and the like, in the control apparatus as the controller 1, the measurement channel CHm that is the measurement target of the radio field strength information may be the channel CH that is selected after the current selected channels CH.

By obtaining the radio field strength information on the channel CH to be selected next in advance, it is possible to quickly change the next selected channel CHs.

Since the communication environment may change constantly, the above configuration in which the selected channel CHs can be changed appropriately based on the most recently measured radio field strength information can allow satisfactory communication with the communication target device (the controlled device 2) and reduce the possibility that the communication target device (the controlled device 2) becomes uncontrollable.

As described in the third embodiment with reference to FIG. 16 or the like, the control part 5 in the control apparatus as the controller 1 may determine whether or not to invalidate the selected channel CHs based on the radio field strength information (the second RSSI value) on the measurement channel CHm, and may select the channel CH other than the invalid channel that has been determined to be invalid in the selection of the selected channel CHs.

By determining the channel CH that has been determined to be unusable due to the presence of interference waves as the invalid channel, a frequency hopping pattern except the invalid channel can be newly created.

Therefore, it is possible to create a frequency hopping pattern using only the channel CH that is less affected by interference waves, and also possible to perform satisfactory communication.

As described in the third embodiment with reference to FIGS. 7, 16, and the like, the control part 5 in the control apparatus as the controller 1 may determine whether or not to validate the invalid channel when the reception data (the return data Dr) is received again.

Hence, the invalid channel is validated appropriately.

Therefore, it is possible to prevent an increase in the number of invalid channels CH and a continuous decrease in the number of usable channels, and also possible to maintain a satisfactory communication environment.

As described in the configuration of the communication system S with reference to FIGS. 1, 6, and the like, the control apparatus as the controller 1 may include the display part 7 capable of presenting information based on the radio field strength information (e.g., spectrum information shown in FIG. 6).

Thus, it is possible to present the interference wave intensity information to a user based on the radio field strength information.

Hence, a user can recognize the possibility of loss of control, and can safely terminate the remote control of the communication target device (the controlled device 2).

As described in the flowchart or the configuration of the communication system S with reference to FIGS. 1, 7, and the like, the control part 5 in the control apparatus as the controller 1 may calculate the interference wave intensity for the measurement channel CHm based on the radio field strength information.

Accordingly, when the interference wave intensity is high, the measurement channel CHm can be prevented from being used later.

As described with reference to FIGS. 1, 12, and the like, the control part 5 in the control apparatus as the controller 1 may perform a warning process depending on the calculated degree of interference.

The degree of interference may be the number of invalid channels, which is the number of channels CH affected by the interference waves, or may be the interference wave intensity.

Accordingly, an operator can safely terminate the remote control of the communication target device (the controlled device 2) before the device becomes uncontrollable.

As described with reference to FIGS. 12, 13, and the like, the control part 5 in the control apparatus as the controller 1 may set a warning condition by the manipulation of the manipulation part 6, and may perform a warning process corresponding to the set warning condition.

Accordingly, the operator can set an appropriate condition, and perform a desired warning process.

As described with reference to FIGS. 12, 13, and the like, the control part 5 in the control apparatus as the controller 1 may determine whether or not to invalidate the measurement channel CHm based on the radio field strength information (the second RSSI value) on the measurement channel CHm, and may performs a warning process when the number of invalid channels determined to be invalid is greater than or equal to a predetermined number.

Thus, the warning process can be performed under the condition that there are fewer channels CH that can be used in frequency hopping.

Hence, an appropriate warning process can be performed before the response speed of the operation of the communication target device (the controlled device 2) for the remote control decreases, or before the communication target device (the controlled device 2) becomes uncontrollable.

As described above, the reception data (the return data Dr) received by the receiver 4R of the control apparatus as the controller 1 may include the radio field strength information (the first RSSI value) on the selected channel CHs as well as the radio field strength information (the second RSSI value) on the measurement channel CHm.

Accordingly, it is possible to efficiently measure the radio field strength information on multiple channels CH.

As described above, the controlled apparatus that is the controlled device 2 includes the receiver 9R for preforming reception of the reception data (the transmission data Ds from the controller 1) at a frequency corresponding to the selected channel CHs selected from the plurality of channels CHs used for frequency hopping, the control part 10 for measuring the radio field strength information (the second RSSI value) on the measurement channel CHm of the measurement target that is the channel CH used for frequency hopping, and the transmitter 9S for performing, in response to the reception, transmission of the transmission data (the return data Dr) at a frequency corresponding to the selected channel CHs used in the reception to the control apparatus (the controller 1) that has transmitted the reception data (the transmission data Ds from the controller 1).

Further, the transmission data (the return data Dr) includes the radio field strength information measured by the control part 10 between the reception of the reception data (the transmission data Ds from the controller 1) and the transmission of the transmission data (the return data Dr).

Further, the communication system S includes the control apparatus (the controller 1) and the controlled apparatus (the controlled device 2).

The control apparatus (the controller 1) includes the control part 5 for determining the selection order of the channels CH in frequency hopping, and the transmitter 4S for performing transmission of the transmission data Ds at a frequency corresponding to the selected channel CHs selected based on the selection order.

Further, the controlled apparatus (the controlled device 2) includes the receiver 9R for performing reception of the transmission data Ds at a frequency corresponding to the selected channel CHs, the control part 10 for measuring the radio field strength information on the measurement channel CHm of the measurement target that is the channel CH used for frequency hopping, and the transmitter 9S for performing, in response to the reception, transmission of the return data Dr including the radio field strength information at a frequency corresponding to the selected channel CHs to the control apparatus (the controller 11).

The above-described various operational effects can also be obtained by the above controlled apparatus or the above communication system S.

The above-described examples can be combined, and the above-described various operational effects can also be obtained in the case of using various combinations.

1. A control apparatus comprising:
a control part configured to determine a channel selection order in frequency hopping;
a transmitter configured to transmit transmission data at a frequency corresponding to a selected channel selected based on the selection order; and
a receiver configured to receive, in response to the transmission, reception data from a communication target device at a frequency corresponding to the selected channel,
wherein the reception data includes radio field strength information on a measurement channel of a measurement target that is a channel used for the frequency hopping.

2. The control apparatus of claim 1, wherein the transmission data transmitted by the transmitter includes control information for controlling a posture or an operation of the communication target device, and
the reception data received by the receiver includes telemetry information on the communication target device and the radio field strength information.

3. The control apparatus of claim 1, wherein the reception data includes a radio field strength information measured after the transmission corresponding to the reception.

4. The control apparatus of claim 3, wherein the measurement channel is the current selected channel.

5. The control apparatus of claim 3, wherein the measurement channel is a channel other than the current selected channel.

6. The control apparatus of claim 5, wherein the measurement channel is a channel to be selected after the current selected channel.

7. The control apparatus of claim 1, wherein the control part determines whether or not to invalidate the measurement channel where the radio field strength information is measured based on the radio field strength information, and
selects a channel other than the invalid channel determined to be invalid in the selection of the selected channel.

8. The control apparatus of claim 7, wherein the control part determines whether or not to validate the invalid channel when the reception data including the radio field strength information on the invalid channel is received again.

9. The control apparatus of claim 1, further comprising:
a display part configured to present information based on the radio field strength information.

10. The control apparatus of claim 1, wherein the control part calculates an interference wave intensity for the measurement channel based on the radio field strength information.

11. The control apparatus of claim 10, wherein the control part performs a warning process depending on a calculated degree of interference.

12. The control apparatus of claim 11, wherein the control part sets a warning condition by manipulation of a manipulation part, and
performs the warning process corresponding to the warning condition.

13. The control apparatus of claim 11, wherein the control part determines whether or not to invalidate the measurement channel where the radio field strength information is measured based on the radio field strength information, and
executes the warning occurs when the number of invalid channels determined to be invalid by the determination is greater than or equal to a predetermined number.

14. The control apparatus of claim 1, wherein the reception data includes information on the selected channel in addition to the radio field strength information on the measurement channel.

15. A controlled apparatus comprising:
a receiver configured to perform reception of a reception data at a frequency according to a selected channel selected from a plurality of channels used for frequency hopping;
a control part configured to measure radio field strength information on a measurement channel of a measurement target that is a channel used for the frequency hopping; and
a transmitter configured to performs, in response to the reception, transmission of a transmission data at a frequency corresponding to the selected channel used in the reception to the control apparatus,
wherein the transmission data includes the radio field strength information measured by the control part between the reception of the reception data and the transmission of the transmission data.

16. A communication system including a control apparatus and a controlled apparatus,
wherein the control apparatus includes:
a control part configured to determine a channel selection order in frequency hopping; and
a transmitter configured to transmit transmission data at a frequency corresponding to a selected channel selected based on the selection order, and
the controlled apparatus includes:
a receiver configured to receive the transmission data at a frequency according to the selected channel;
a control part configured to measures radio field strength information on a measurement channel of a measurement target that is a channel used for the frequency hopping; and
a transmitter configured to perform, in response to the reception, transmission of return data including the radio field strength information at a frequency corresponding to the selected channel to the control apparatus.
